(19) United States
(12) Patent Application Publication
(10) Pub. No.: US 2025/0315141 A1
(43) Pub. Date: Oct. 9, 2025

(54) DISPLAY METHOD FOR DISPLAY DEVICE AND NON-TRANSITORY COMPUTER READABLE RECORDING MEDIUM

(71) Applicant: Getac Technology Corporation, New Taipei City (TW)

(72) Inventors: Shih-Hui CHENG, Taipei City (TW); Po-Yang KUO, Taipei City (TW)

(21) Appl. No.: 19/001,658

(22) Filed: Dec. 26, 2024

Related U.S. Application Data
(60) Provisional application No. 63/573,733, filed on Apr. 3, 2024.

(51) Int. Cl. G06F 3/0481; G06F 3/04883; G06F 3/16; G10L 15/22

(52) U.S. Cl. CPC G06F 3/0481; G06F 3/04883; G06F 3/167; G10L 15/22; G10L 2015/223

(57) ABSTRACT

A display method for a display device includes the following steps. A user interface when an application is executed is displayed. An input command is received. The user interface of the application is switched among a window, a widget, and a status bar according to the input command. A size of the window is larger than a size of the widget, and a height of the status bar is less than a height of the widget.

### RELATED APPLICATIONS

This application claims priority to U.S. Provisional Application Ser. No. 63/573,733, filed Apr. 3, 2024, which is herein incorporated by reference in its entirety.

### BACKGROUND

### Field of Invention

The present disclosure relates to a display method for a display device and a non-transitory computer readable recording medium. More particularly, the present disclosure relates to display method for a display device and a non-transitory computer readable recording medium adapted for displaying a voice user interface.

### Description of Related Art

In currently existing user interfaces, the user interface of each speech-to-text application (such as a speech assistant) usually has only a single structural element, such as an application window, a widget, or a floating action button. Under this circumstance, when users use other applications to perform specific tasks in conjunction with the speech assistant, no matter if it is scaling the application window or dragging the widget or floating operation button, the structural element of the speech assistant in the related art is prone to blocking information included in the windows of other applications to causing interferences. Therefore, there is a need to provide a display method and a non-transitory computer readable recording medium to resolve the above problem, which is also an important issue in this field.

### SUMMARY

A display method for a display device is provided. The display method for the display device includes the following steps. A user interface when an application is executed is displayed. An input command is received. The user interface of the application is switched between a window, a widget, and a status bar according to the input command. A size of the window is larger than a size of the widget, and a height of the status bar is less than a height of the widget.

The present disclosure provides a display method for a display device. The display method for the display device includes the following steps. A user interface when an application is executed is displayed. Data is obtained. The user interface of the application is switched between a window, a widget, and a status bar according to the data. A size of the window is larger than a size of the widget, and a height of the status bar is less than a height of the widget.

The present disclosure further provides a non-transitory computer readable recording medium. The non-transitory computer readable recording medium is configured to store an application including a plurality of instructions. The processing circuit performs the following operations when the processing circuit executes the instructions. An input command is received. A user interface of an application is switched between a window, a widget, and a status bar according to the input command. A size of the window is larger than a size of the widget, and a height of the status bar is less than a height of the widget. The user interface when the application is executed is displayed by a display.

In summary, the display method of the present disclosure can switch the user interface of the application to the status bar from the window or the widget, so as to avoid blocking the content of other windows displayed below. As a result, user experience is improved.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure. In the drawings,

FIG. 1A to FIG. 1C depict schematic diagrams of structural elements of an application according to some embodiments of the present disclosure;

FIG. 2 depicts a schematic diagram of a display device according to some embodiments of the present disclosure;

FIG. 3A to FIG. 3C depict schematic diagrams of a window, a widget, or a status bar of an application displayed by a display device according to some embodiments of the present disclosure;

FIG. 4A depicts a flowchart of a display method for a display device according to some embodiments of the present disclosure;

FIG. 4B depicts a flowchart of step S430 of the display method in FIG. 4A according to some embodiments of the present disclosure;

FIG. 4C depicts a flowchart of step S410 of the display method in FIG. 4A according to some embodiments of the present disclosure;

FIG. 5 depicts a schematic diagram of a window of an application according to some embodiments of the present disclosure;

FIG. 6A and FIG. 6B depict schematic diagrams of widgets of an application according to some embodiments of the present disclosure;

FIG. 6C and FIG. 6D depict schematic diagrams of transitions of widgets of an application among different states according to some embodiments of the present disclosure;

FIG. 7A depicts a schematic diagram of a status bar of an application according to some embodiments of the present disclosure;

FIG. 7B and FIG. 7C depict schematic diagrams of transitions of status bars of an application among different states according to some embodiments of the present disclosure;

FIG. 8 depicts a schematic diagram of a display method according to some embodiments of the present disclosure;

FIG. 9 depicts a schematic diagram of a display method according to some embodiments of the present disclosure;

FIG. 10A to FIG. 10B depict schematic diagrams of window configurations according to some embodiments of the present disclosure; and

FIG. 11A to FIG. 11B depict schematic diagrams of window configurations according to some embodiments of the present disclosure.

### DESCRIPTION OF THE EMBODIMENTS

Reference will now be made in detail to the present embodiments of the disclosure, examples of which are illustrated in the accompanying drawings. However, the embodiments provided herein are intended as illustrative only since numerous modifications and variations therein will be apparent to those skilled in the art. Description of the operation does not intend to limit the operation sequence. Any structures resulting from recombination of components with equivalent effects are within the scope of the present disclosure. In addition, drawings are only for the purpose of illustration and not plotted according to the original size. Wherever possible, the same reference numbers are used in the drawings and the description to refer to the same or like parts for better understanding. Terms used throughout the specification and the claims typically have common meanings for each of the terms used in this field, in the present disclosure and in special contents, unless specially noted. Furthermore, it should be understood that the terms, “comprising”, “including”, “having”, “containing”, “involving” and the like, used herein are open-ended, that is, including but not limited to. As used herein, the term “and/or” includes any and all combinations of one or more of the associated listed items.

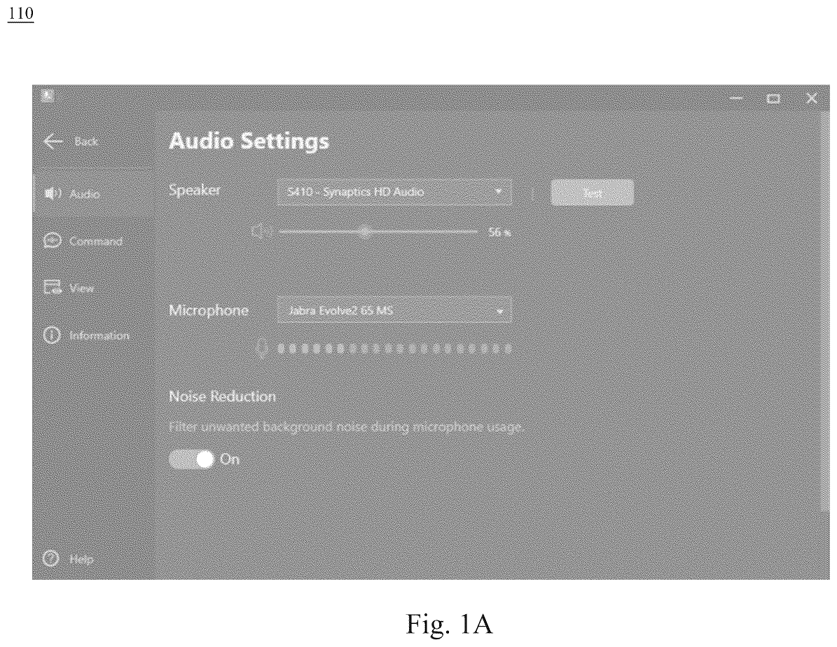

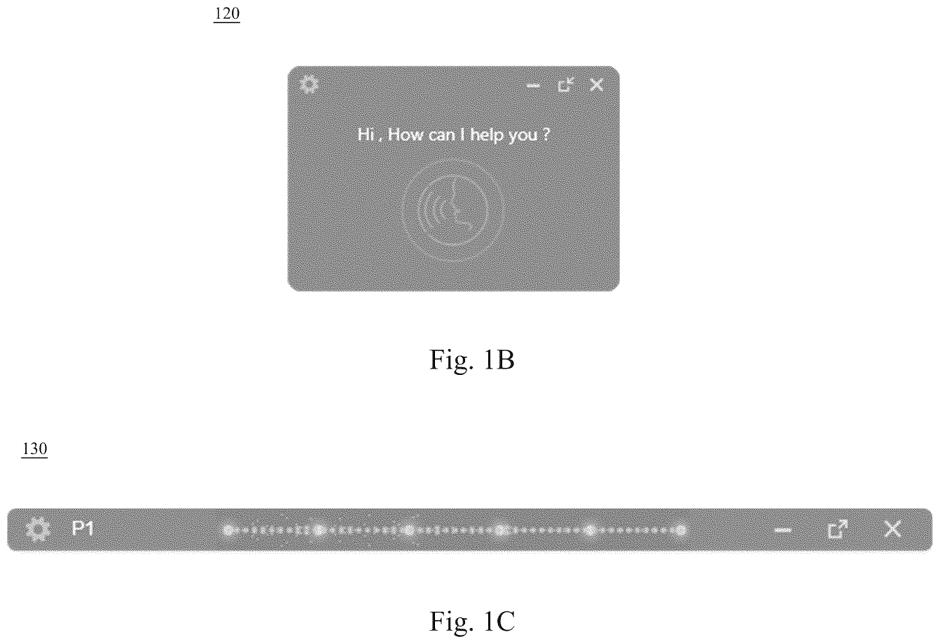

A description is provided with reference to FIG. 1A to FIG. 1C. FIG. 1A to FIG. 1C depict schematic diagrams of structural elements of an application according to some embodiments of the present disclosure. As shown in FIG. 1A to FIG. 1C, the structural elements of the application include a window 110, a widget 120, and a status bar 130. In some embodiments, the application is a speech conversion application. In some embodiments, the application is a speech-to-text application. In some embodiments, the application is a speech assistant or other application with speech recognition function. However, the present disclosure is not limited in this regard.

In some embodiments, window elements of the window 110 include detailed information of the application or an audio setting configuration. The audio setting configuration includes a volume level of a microphone. In some embodiments, the audio setting configuration includes a noise reduction button. In some embodiments, the audio setting configuration includes a volume slider for a speaker. In some embodiments, the audio setting configuration includes the respective names/models of the selected microphone and speaker.

In some embodiments, a widget element of the widget 120 includes a working state of the application, for example, a standby state, a listening state, or a speech conversion state. For example, the standby state of the application can be presented by a description, such as “Hi, How can I help you?”, or other descriptions/icons. For another example, the listening state of the application can be presented by a description “Listening”, or other descriptions/icons. However, the present disclosure is not limited in this regard. In some embodiments, the widget element of the widget 120 further includes a speaking prompt or a conversion complete prompt. For example, the speaking prompt may be the side face profile and the sound wave pattern that expands outwards from the lips in FIG. 1B. In other embodiments, the speaking prompt can be some other pattern/description. The present disclosure is not limited in this regard.

In some embodiments, a status bar element of the status bar 130 includes the working state of the application, for example, the listening state or the speech conversion state. In some embodiments, the status bar element of the status bar 130 includes a digital sound waveform. The digital sound waveform can be used as a reference for the volume of sound received by the microphone. In some embodiments, based on the digital sound waveform presented by the status bar 130, a user can directly confirm whether or not a recording is currently being performed, and determine whether or not the volume of sound received by the microphone is too low or the low-frequency noise is too much, so that application settings need to be adjusted. As a result, the voice quality in audio is improved to be able to obtain a more complete text record during the speech conversion process.

In some embodiments, the user can control a user interface of the application to be switched between the window 110, the widget 120, and the status bar 130 through a speech command or touching a screen. In some other embodiments, the user can control the user interface of the application to be switched between the window 110, the widget 120, and the status bar 130 through using a mouse to click so as to control a button on the user interface. The present disclosure is not limited in this regard.

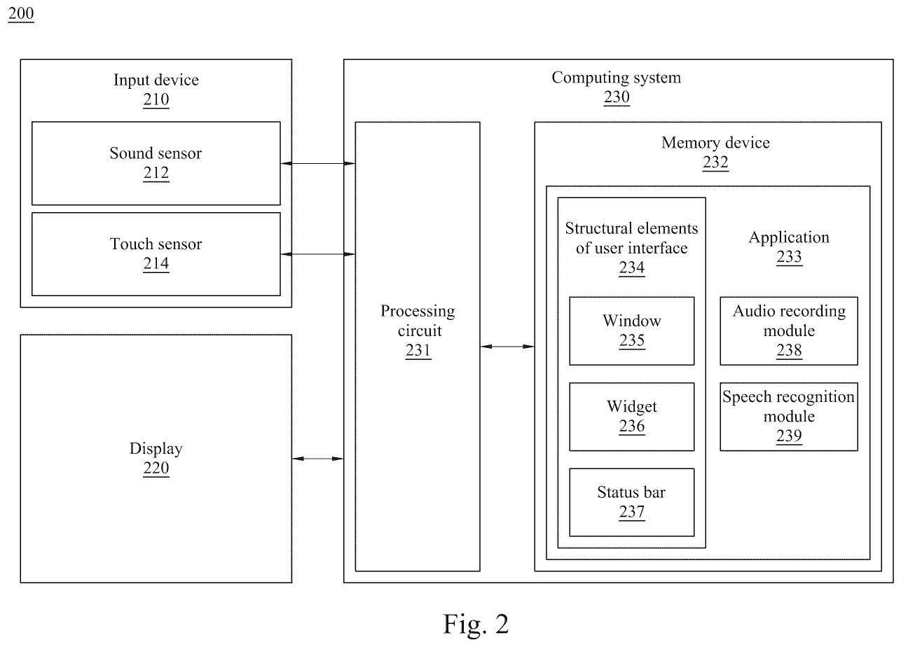

A description is provided with reference to FIG. 2. FIG. 2 depicts a schematic diagram of a display device 200 according to some embodiments of the present disclosure. In some embodiments, the display device 200 is an electronic device with a display 220. In some embodiments, the display device 200 includes an input device 210, the display 220, and a computing system 230. In some embodiments, the input device 210 includes a sound sensor 212, a touch sensor 214, a mouse and/or a touchpad, or other input device. The present disclosure is not limited in this regard. In some embodiments, the display device 200 is a mobile device, such as a notebook computer, a tablet computer. In some embodiments, the display device 200 is a touch display device with the touch sensor 214 and the display 220. In some embodiments, the display device 200 is an on-board computer. In some embodiments of the present disclosure, the operation of speech recognition can be performed by a local device (such as the display device). In other embodiments, the operation of speech recognition can be performed by a cloud server. The present disclosure is not limited in this regard.

In some embodiments, during the driving period of vehicle, if a driver or passenger wants to query information by speech or perform a text recording through speech to text, the window switching between a speech recognition application and other collaborative applications may cause interferences. Hence, in some embodiments, an optimized interface design of the present disclosure can be adapted for window configuration when performing multiple tasks. By switching user interface components of the application which is used for speech recognition between the window, the widget, and the status bar, the interferences on the original operation can be improved and a user is allowed to keep the interaction method in which multiple tasks are operated.

In some embodiments, the computing system 230 includes a processing circuit 231 and a memory device 232. In some embodiments, the memory device 232 may include a dynamic memory, a static memory, a hard disk, and/or a flash memory. In some embodiments, the memory device 232 is configured to store data (such as, structural elements of user interface 234 of the application 233) and computer executable instructions (such as an audio recording module 238 and a speech recognition module 239 of the application 233). In some embodiments, the structural elements of user interface 234 of the application 233 include a window 235, a widget 236, and a status bar 237. In some embodiments, the window 235, the widget 236, and the status bar 237 have different sizes. In some embodiments, any two of the window 235, the widget 236, and the status bar 237 of the application 233 are not opened at the same time. In some embodiments, three of the window 235, the widget 236, and the status bar 237 of the application 233 are not opened at the same time.

In some embodiments, the window 235, the widget 236, and the status bar 237 included in the structural elements of user interface 234 of the application 233 in FIG. 2 respectively correspond to the window 110, the widget 120, and the status bar 130 of the application in FIG. 1A to FIG. 1C.

In some embodiments, the size of the window 235 is larger than the size of the widget 236. In some embodiments, a width of the window 235 is greater than a width of the widget 236, and a height of the window 235 is greater than a height of the widget 236.

In some embodiments, the height of the widget 236 is greater than a height of the status bar 237. In other words, the height of the status bar 237 is less than the height of the widget 236. In some embodiments, a width of the status bar 237 is not less than the width of the widget 236. In other words, the width of the status bar 237 is greater than or equal to the width of the widget 236.

In some embodiments, the height of the status bar 237 is not greater than a height of a title bar of the window 235 and/or the widget 236. In other words, the height of the status bar 237 is less than or equal to the height of the title bar of the window 235 and/or the widget 236.

In some embodiments, the processing circuit 231 is electrically coupled to the memory device 232, and accesses data or instructions from the memory device 232 to perform audio recording, speech recognition and/or window switching. In some embodiments, the processing circuit 231 includes a central processing unit, a graphics processing unit, a tensor processing unit, an application-specific integrated circuit, or any equivalent processing circuit. In some embodiments, the processing circuit 231 utilizes the audio recording module 238 of the application 233 to record audio, and the processing circuit 231 utilizes the speech recognition module 239 of the application 233 to recognize speech from the audio and to convert the speech r into a text record. In some embodiments, a working state of the application 233 includes a listening state or a speech conversion state. In some embodiments, in the listening state, the application 233 is executed to recognize whether speech exists in an audio signal received by the sound sensor 212 or not. When the speech exists in the audio signal, the working state of the application 233 is switched from the listening state to the speech conversion state, and the application 233 is executed in the speech conversion state to convert an audio segment corresponding to the speech into the text record. In some embodiments, the application 233 may be executed by the processing circuit 231.

In some embodiments, the processing circuit 231 receives an input command from the input device 210. In some embodiments, the input command may be a touch command from the touch sensor 214 or a speech command recognized from a sound signal received by the sound sensor 212 by the processing circuit 231 by using the speech recognition module 239. In other embodiments, the input command may be a click command from a mouse, a touch panel, or data/command being able to be provided by some other input device. Hence, the present disclosure is not limited in this regard. In some embodiments, the processing circuit 231 switches the user interface of the application 233 among the window 235, the widget 236, and the status bar 237 according to the input command. In some embodiments, the application 233 is an auxiliary program. In some embodiments, the application 233 is used to assist another application. In some embodiments, the status bar 237 of the application 233 can be pinned above all other windows.

In some embodiments, the status bar 237 covers a portion of a title bar of an application window displayed below the status bar 237. In some embodiments, the height of the status bar 237 of the application 233 is not greater than a height of the title bar of the application window displayed below the status bar 237. The application of the application window displayed below may be a program that operates in conjunction with the application 233. In some embodiments, the other application that operates in conjunction with the application 233 may be an email program, a word creating and processing program, or other program related to text adding/editing. The present disclosure is not limited in this regard. In some embodiments, when the user wants to convert speech to text through the speech recognition module 239 of the application 233 to write content, for example, to write a report document, to draft an email, etc., the user interface of the application 233 can be switched to the status bar 237 by the speech command or the touch command. Under this circumstance, the input content of speech presented by the window of the other application that operates in conjunction with the application 233 (such as, the email program, the word creating and processing program) is not blocked by the user interface of the application 233, and the sound volume of the microphone and/or the working state of the application 233 can be directly viewed through the status bar 237.

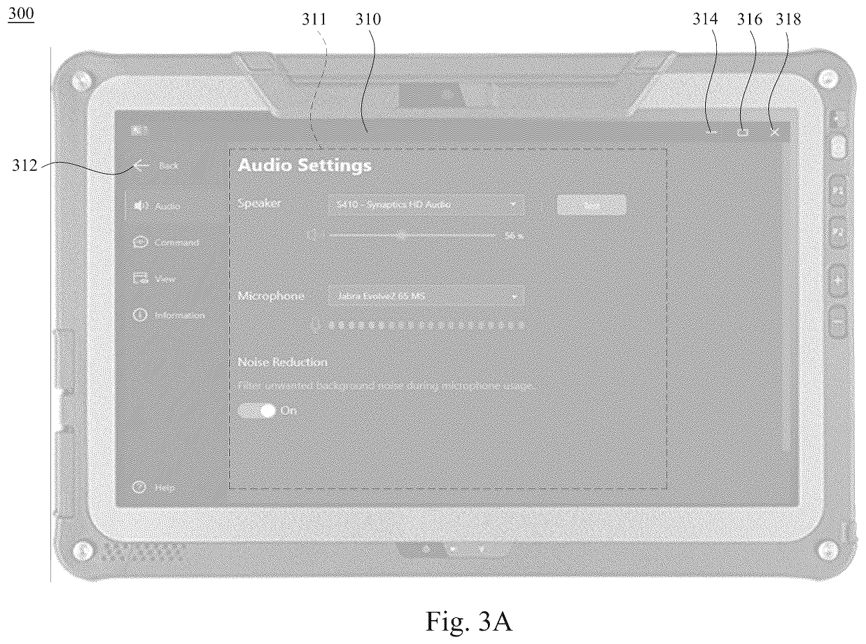

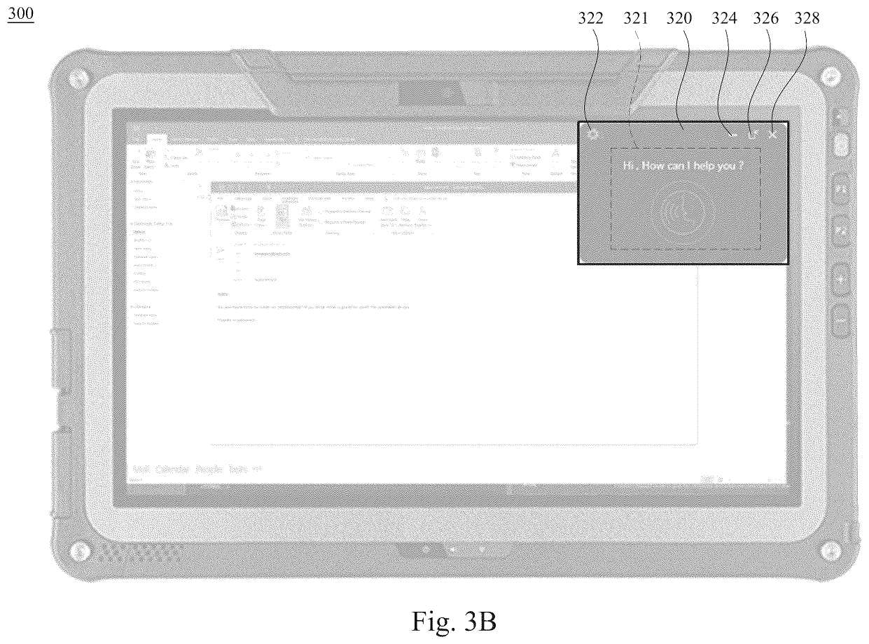

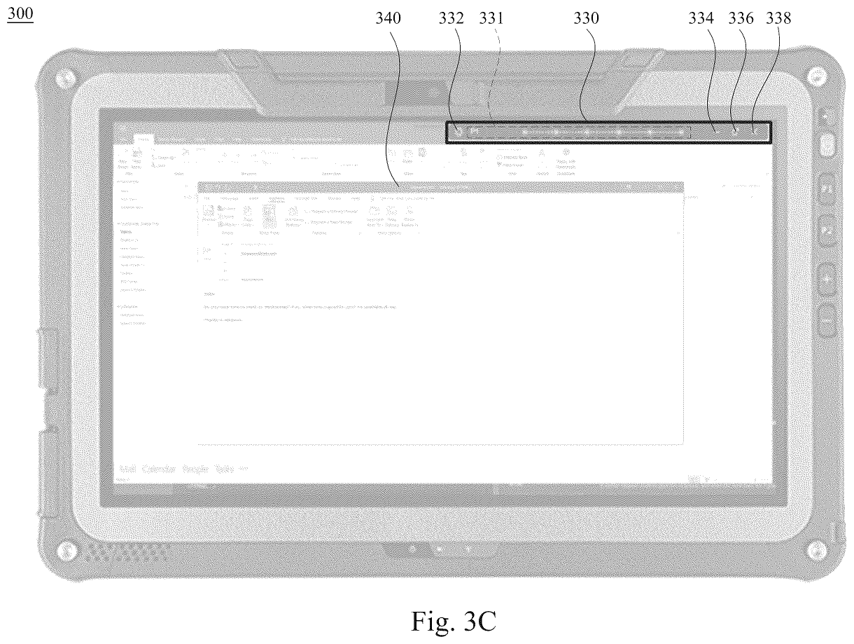

A description is provided with reference to FIG. 3A to FIG. 3C. FIG. 3A to FIG. 3C depict schematic diagrams of a window 310, a widget 320, or a status bar 330 of an application displayed by a display device 300 according to some embodiments of the present disclosure. In some embodiments, the display device 300 of FIG. 3A to FIG. 3C corresponds to the display device 200 of FIG. 2, and the window 310, the widget 320, and the status bar 330 of the application in FIG. 3A to FIG. 3C respectively correspond to the window 235, the widget 236, and the status bar 237 of the application 233 in FIG. 2.

As shown in FIG. 3A, a window element 311 of the window 310 includes an audio setting configuration of the application. The audio setting configuration includes a volume level of a microphone, a noise reduction button, a volume slider for a speaker, and respective names/models of the microphone and speaker. In some embodiments, to the right of a title bar of the window 310 are a minimize button 314, a full screen button 316, and a close button 318. In some embodiments, the minimize button 314 is presented with an underline, and is used to shrink a user interface of the application (such as the window 310) to a taskbar. In some embodiments, the full screen button 316 is presented with a rectangular frame, and is used to switch the window 310 of the application to the full screen mode. In some embodiments, the close button 318 is presented with a cross symbol, and is used to close the application.

In some embodiments, a sidebar of the window 310 has a back button 312. In some embodiments, the back button 312 is presented with an arrow pointing to the left (or to the outside), which is used to restore the window 235 of the application to a previous user interface, and the previous user interface is the widget 320 or the status bar 330. In some embodiments, the window 310 includes options for sound, instructions, views, and information. In some embodiments, the audio setting configuration of the application is presented in the page of sound options.

As shown in FIG. 3B, a widget element 321 of the widget 320 includes a working state of the application, for example, a standby state, a listening state, or a speech conversion state. For example, the standby state of the application can be presented by a description, such as “Hi, How can I help you?”, or other descriptions/icons. The present disclosure is not limited in this regard. In some embodiments, the widget element 321 of the widget 320 further includes a speaking prompt or a conversion complete prompt. For example, the speaking prompt may be the side face profile and the sound wave pattern that expands outwards from the lips in FIG. 3B. In other embodiments, the speaking prompt can be some other pattern/description. The present disclosure is not limited in this regard.

In some embodiments, to the left of a title bar of the widget 320 is a window button 322, and to the right of the title bar of the widget 320 are a minimize button 324, a status bar button 326, and a close button 328. In some embodiments, the window button 322 is presented with a gear, and is used to switch the user interface of the application (such as the widget 320) to the window 310. In some embodiments, the minimize button 324 is presented with an underline, and is used to shrink the user interface of the application (such as the widget 320) to a taskbar. In some embodiments, the status bar button 326 is presented with a square frame and an arrow pointing to an inside of the square frame in a bottom right direction, and is used to switch the user interface of the application (such as the widget 320) to the status bar 330. In some embodiments, the close button 328 is presented with a cross pattern, and is used to close the application.

In some embodiments, when a user uses the speech conversion function of the widget 320 to assist another application (such as an email application), the widget 320 will still block an application window displayed below. At this time, the user can switch the user interface of the application (such as the widget 320) to the status bar 330 through a speech command or a touch command (such as touching the status bar button 326).

As shown in FIG. 3C, in some embodiments, a height of the status bar 330 is less than a height of a title bar of an application window 340 (such as a window of an email program) displayed below. In this manner, input content of the speech presented by the application window 340 displayed below the status bar 330 is not blocked by the status bar 330, and the sound volume of the microphone and/or the working state can be directly viewed through a status bar element 331 of the status bar 330.

In some embodiments, the status bar element 331 of the status bar 330 includes the working state of the application, for example, the listening state or the speech conversion state, and a digital sound waveform. The digital sound waveform can be used as a reference for the volume of sound received by the microphone. In some embodiments, based on the digital sound waveform presented by the status bar 330, the user can directly confirm whether or not a recording is currently being performed, and determine whether or not the volume of sound received by the microphone is too low or the low-frequency noise is too much, so that the user interface of the application needs to be switched to the window 310 to adjust the volume of the microphone or turn on the noise reduction button, and the user interface of the application can be switched back to the status bar 330 through the back button 312 after the setting is completed. As a result, a more complete text record is obtained during the speech conversion process.

In some embodiments, the status bar 330 includes a window button 332, a minimize button 334, a widget button 336, and a close button 338. In some embodiments, the window button 332 is used to switch the user interface of the application (such as the status bar 330) to the window 310. In some embodiments, the minimize button 334 is presented with an underline, and is used to shrink the user interface of the application (such as the status bar 330) to a taskbar. In some embodiments, the widget button 336 is presented with a square frame and an arrow pointing to an outside of the square frame in a up right direction, and is used to switch the user interface of the application (such as the status bar 330) to the widget 320. In some embodiments, the close button 338 is presented with a cross symbol, and is used to close the application.

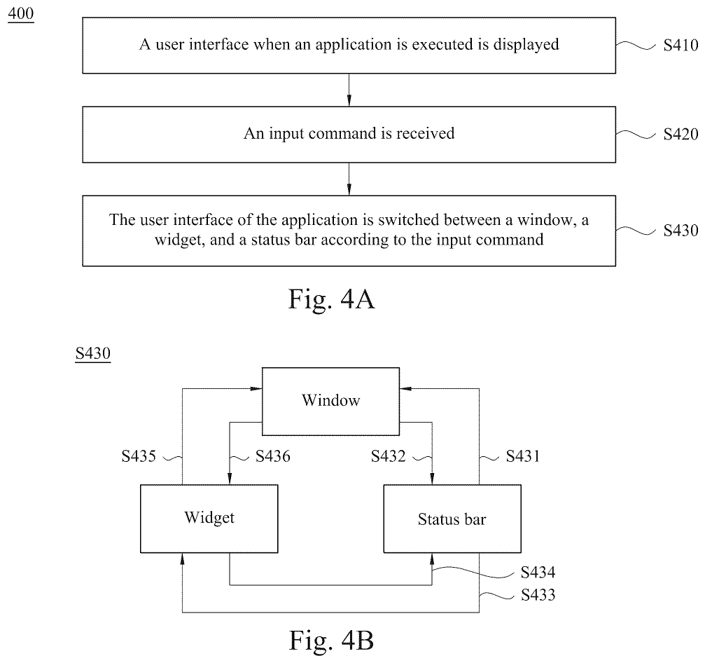

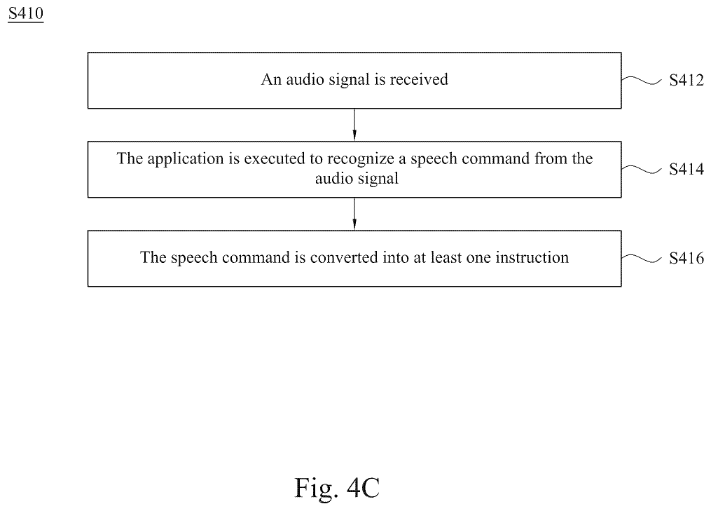

A description is provided with reference to FIG. 2 and FIG. 4A. FIG. 4A depicts a flowchart of a display method 400 for a display device according to some embodiments of the present disclosure. In some embodiments, the display method 400 can be performed by the display device 200 of FIG. 2. In some embodiments, the display method 400 includes steps S410, S420, and S430. In some embodiments, step S410 can be performed by the display 220 of the display device 200, and steps S420 and S430 can be performed by the processing circuit 231 included in the computing system 230 of the display device 200 through accessing data and instructions in the memory device 232. In some embodiments, the memory device 232 corresponds to a non-transitory computer readable recording medium. The non-transitory computer readable recording medium is configured to store a plurality of instructions. When the processing circuit 231 executes these instructions, the processing circuit 231 performs operations of steps S420 and S430.

In step S410, a user interface when an application is executed is displayed. In some embodiments, the processing circuit 231 can instruct/control the display 220 to display a user interface when the application 233 is executed. In some embodiments, the application 233 is a speech recognition application. In some embodiments, the application 233 is a speech assistant. Since the description of the application 233 has been provided in the embodiment of FIG. 2, a description in this regard is not repeated.

In step S420, an input command is received. In some embodiments, the input command may be a touch command, a speech command, or a click command. Since the device that provides the input command has been provided in the embodiment of FIG. 2, a description in this regard is not repeated.

In step S430, the user interface of the application is switched between a window, a widget, and a status bar according to the input command. In some embodiments, the window, the widget, and the status bar correspond to the window 235, the widget 236, and the status bar 237 of the application 233 of FIG. 2.

A description is provided with reference to FIG. 2, FIG. 3A to FIG. 3C, and FIG. 4B. FIG. 4B depicts a flowchart of step S430 of the display method in FIG. 4A according to some embodiments of the present disclosure. As shown in FIG. 4B, step S430 includes steps S431-S436. In some embodiments, steps S431-S436 can be performed by the processing circuit 231 included in the computing system 230 according to the input command through accessing data and instructions in the memory device 232.

In step S431, the status bar is switched to the window. For example, though touching/clicking the window button 332 of the status bar, the status bar 330 can be switched to the window 310. For another example, the speech recognition module 239 of the application 233 recognizes a speech command, such as “switch to the status bar”, to switch the status bar 330 to the window 310.

In step S432, the window is switched to the status bar. For example, through touching/clicking the back button 312 of the window 310, the window can be restored to the status bar 330. For another example, the speech recognition module 239 of the application 233 recognizes a speech command, such as “switch to the status bar”, to restore the window 310 to the status bar 330.

In step S433, the status bar is switched to the widget. For example, though touching/clicking the widget button 336 of the status bar 330, the status bar 330 can be switched to the widget 320. For another example, the speech recognition module 239 of the application 233 recognizes a speech command, such as “switch to the widget”, to switch the status bar 330 to the widget 320.

In step S434, the widget is switched to the status bar. For example, though touching/clicking the status bar button 326 of the widget 320, the widget 320 can be switched to the status bar 330. For another example, the speech recognition module 239 of the application 233 recognizes a speech command, such as “switch to the status bar”, to switch the widget 320 to the status bar 330.

In step S435, the widget is switched to the window. For example, though touching/clicking the window button 322 of the widget 320, the widget 320 can be switched to the window 310. For another example, the speech recognition module 239 of the application 233 recognizes a speech command, such as “switch to the window”, to switch the widget 320 to the window 310.

In step S436, the window is switched to the widget. For example, through touching/clicking the back button 312 of the window 310, the window can be restored to the widget 320. For another example, the speech recognition module 239 of the application 233 recognizes a speech command, such as “switch to the widget”, to restore the window 310 to the widget 320.

A description is provided with reference to FIG. 2 and FIG. 4C. FIG. 4C depicts a flowchart of step S410 of the display method in FIG. 4A according to some embodiments of the present disclosure. In some embodiments, step S410 includes steps S412, S414, and S416. In some embodiments, steps S412, S414, and S416 can be performed by the processing circuit 231 included in the computing system 230 according to the input command through accessing data and instructions in the memory device 232.

In step S412, an audio signal is received. In some embodiment, the sound sensor 212 receives the audio signal/a sound signal and provides the said signal to the processing circuit 231.

In step S414, the application is executed to recognize a speech command from the audio signal. In some embodiments, the processing circuit 231 executes the application 233 to recognize the speech command in the audio signal/the sound signal.

In step S416, the speech command is converted into at least one instruction. In some embodiments, the processing circuit 231 recognizes the speech command and/or converts the speech command into the input command.

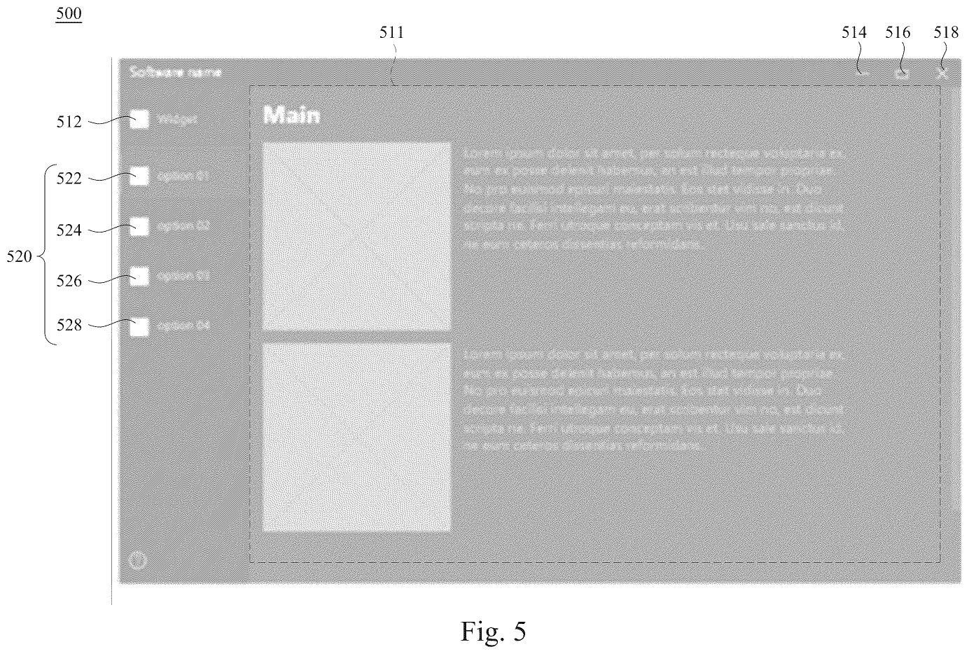

A description is provided with reference to FIG. 5. FIG. 5 depicts a schematic diagram of a window 500 of an application according to some embodiments of the present disclosure. As shown in FIG. 5, a title bar of the window 500 includes a minimize button 514, a full screen button 516, and a close button 518. In some embodiments, a sidebar of the window 500 includes a back button 512 and options 520. In some embodiments, the options 520 include a sound option 522, an instruction option 524, a view option 526, and an information option 528. These options may be selectively configured, and the present disclosure is not limited in this regard. In some embodiments, the window 500 includes a window element 511 for presenting setting configuration and/or detailed information of the application, etc., associated with information of the application.

In some embodiments, the window 500 of FIG. 5 corresponds to the window 235 of FIG. 2. In some embodiments, functions of the minimize button 514, the full screen button 516, the close button 518, and the back button 512 of the window 500 in FIG. 5 correspond to functions of the minimize button 314, the full screen button 316, the close button 318, and the back button 312 of the window 310 in FIG. 3A, and a description in this regard is not provided.

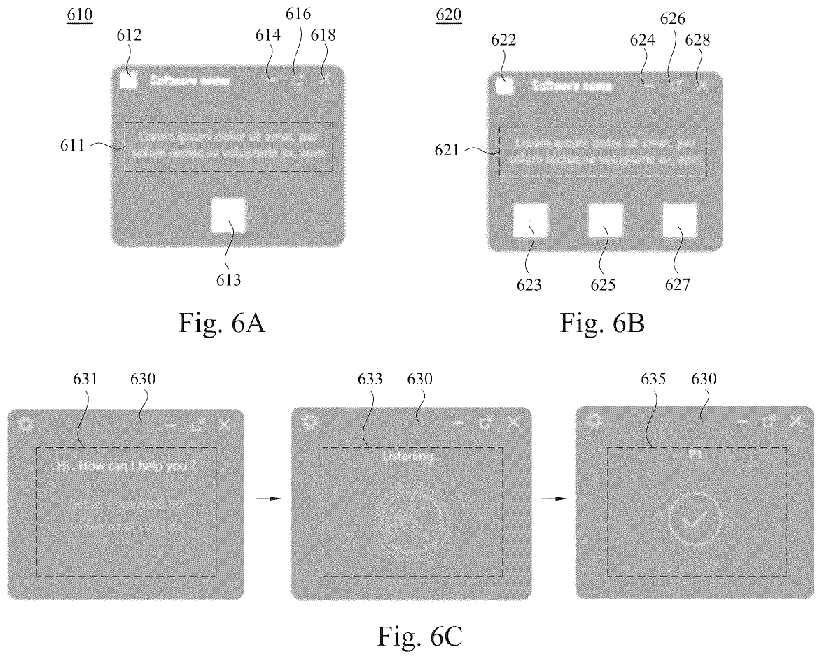

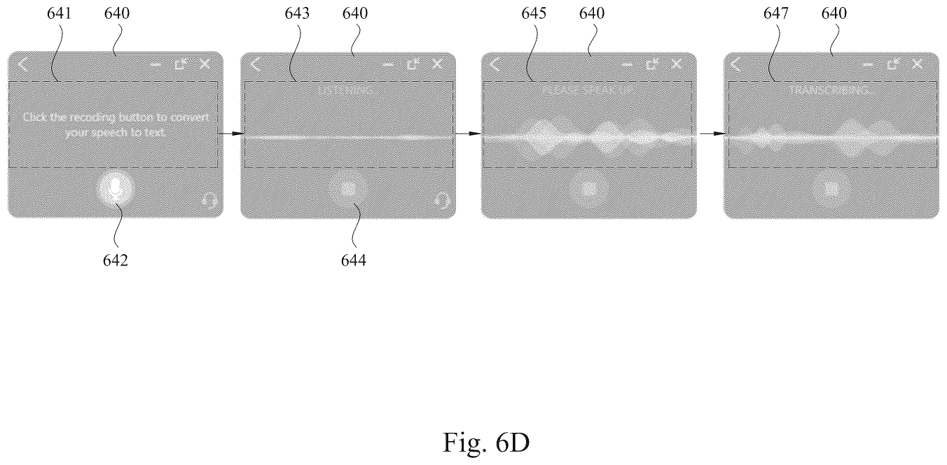

A description is provided with reference to FIG. 6A and FIG. 6B. FIG. 6A and FIG. 6B depict schematic diagrams of widgets 610, 620 of an application according to some embodiments of the present disclosure.

As shown in FIG. 6A, a title bar of the widget 610 includes a window button 612, a minimize button 614, a status bar button 616, and a close button 618. In some embodiments, the widget 610 includes an option 613. The option 613 may be a recording button/pause button or other operation option related to the application. In some embodiments, the option 613 can be configured selectively, and the present disclosure is not limited in this regard. In some embodiments, a widget element 611 of the widget 610 may be used to represent the current working state of the application or the prompt/information interacted with a user.

As shown in FIG. 6B, a title bar of the widget 620 includes a window button 622, a minimize button 624, a status bar button 626, and a close button 628. In some embodiments, the widget 620 includes options 623, 625, and 627. Each of the options 623, 625, and 627 may be a recording button/pause button or other operation option related to the application. In some embodiments, the options 623, 625, and 627 can be configured selectively, and the present disclosure is not limited in this regard. In some embodiments, a widget element 621 of the widget 620 may be used to represent the current working state of the application or the prompt/information interacted with a user.

In some embodiments, the widget 610 of FIG. 6A and the widget 620 of FIG. 6B correspond to the widget 236 of FIG. 2. In some embodiments, functions of the window button 612, the minimize button 614, the status bar button 616, and the close button 618 included in the title bar of the widget 610 in FIG. 6A and functions of the window button 622, the minimize button 624, the status bar button 626, and the close button 628 included in the title bar of the widget 620 in FIG. 6B correspond to functions of the window button 322, the minimize button 324, the status bar button 326, and the close button 328 of the widget 320 in FIG. 3B.

A description is provided with reference to FIG. 6C and FIG. 6D. FIG. 6C and FIG. 6D depict schematic diagrams of transitions of widgets 630, 640 of an application among different states according to some embodiments of the present disclosure.

As shown in FIG. 6C, a widget element 631 of the widget 630 presents a description “Hi, How can I help you?” to indicate a standby state. Then, if a user starts to speak, a widget element 633 of the widget 630 presents a description “Listening . . . ” to indicate a listening state. Finally, after recognizing the user's speech, a widget element 635 of the widget 630 presents a description “P1” and a tick pattern to indicate the completion of speech conversion.

As shown in FIG. 6D, the widget 640 includes a recording button 642. A widget element 641 of the widget 640 presents a description “Click the recording button to convert your speech to text.” to indicate the standby state. Then, after the user clicks the recording button 642, the application enters the listening state. In the listening state, the widget 640 includes a pause button 644, and the listening state is indicated through a widget element 643 of “Listening . . . ” and a digital audio waveform. If the user starts to speak, the digital audio waveform in a widget element 645 of the widget 640 will start to change to reflect the volume of received sound, and the application enters a speech conversion state. In the speech conversion state, a widget element 647 of the widget 640 includes a description “TRANSCRIBING” and a digital waveform of the continuously recorded sound.

In some embodiments, functions of the other buttons of the widget 630 and the widget 640 correspond to functions of the widget 610 of FIG. 6A, the widget 620 of FIG. 6B, or the widget 320 of FIG. 3C, and a description in this regard is not provided.

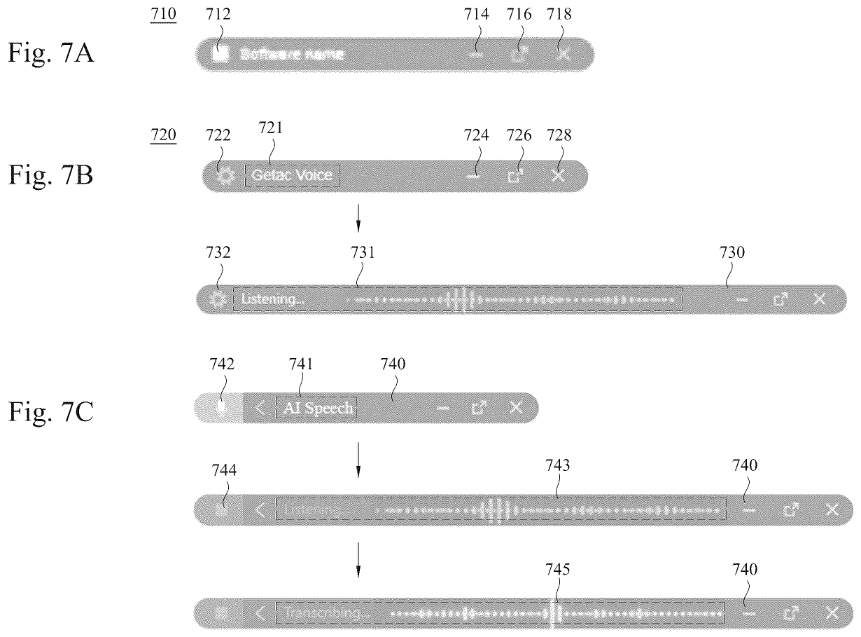

A description is provided with reference to FIG. 7A. FIG. 7A depicts a schematic diagram of a status bar 710 of an application according to some embodiments of the present disclosure. In some embodiments, the status bar 710 corresponds to the status bar 237 of FIG. 2. As shown in FIG. 7A, the status bar 710 includes a window button 712, a minimize button 714, a widget button 716, and a close button 718. In some embodiments, functions of the window button 712, the minimize button 714, the widget button 716, and the close button 718 of the status bar 710 correspond to functions of the window button 332, the minimize button 334, the widget button 336, and the close button 338 of the status bar 330 in FIG. 3C, and description in this regard is not provided.

A description is provided with reference to FIG. 7B and FIG. 7C. FIG. 7B and FIG. 7C depict schematic diagrams of transitions of status bars 720, 730, 740 of an application among different states according to some embodiments of the present disclosure.

As shown in FIG. 7B, when the application is in a standby state, a status bar element 721 of the status bar 720 of the application includes an application name. In some embodiments, the status bar 720 includes a window button 722, a minimize button 724, a widget button 726, and a close button 728. In some embodiments, when a user starts to speak, the application enters a listening state. At this time, a width of the status bar 720 is extended to become the status bar 730. The status bar 730 includes a window button 732, and a status bar element 731 of the status bar 730 includes a state description of the application (for example, “Listening . . . ”) and a digital sound waveform. In some embodiments, after not receiving an audio signal for a period of time, the status bar 730 is switched to the narrower status bar 720 to reduce the interferences on other window(s) displayed below caused by a user interface of the application to the maximum degree.

As shown in FIG. 7C, in some embodiments, the status bar 740 includes a recording button 742 or a pause button 744. In some embodiments, the recording button is used to start recording, and the pause button is used to pause recording. In some embodiments, in the standby state of the application, the status bar 740 of the application includes the recording button 742 and a status bar element 741. In some embodiments, after the user touches/clicks the recording button 742, the application enters the listening state. The status bar 740 of the application includes the pause button 744, and a status bar element 743 of the status bar 740 of the application includes the state description of the application (for example, “Listening . . . ”) and the digital sound waveform. In some embodiments, when user speaking is detected, the application enters a speech conversion state. The status bar 740 of the application includes the pause button 744, and a status bar element 745 of the status bar 740 of the application includes the state description of the application (for example, “Transcribing . . . ”) and the digital sound waveform.

In some embodiments, functions of the other buttons of the status bars 720, 730, and 740 correspond to functions of the status bar 710 of FIG. 7A or functions of the status bar 330 of FIG. 3C, and a description in this regard is not provided.

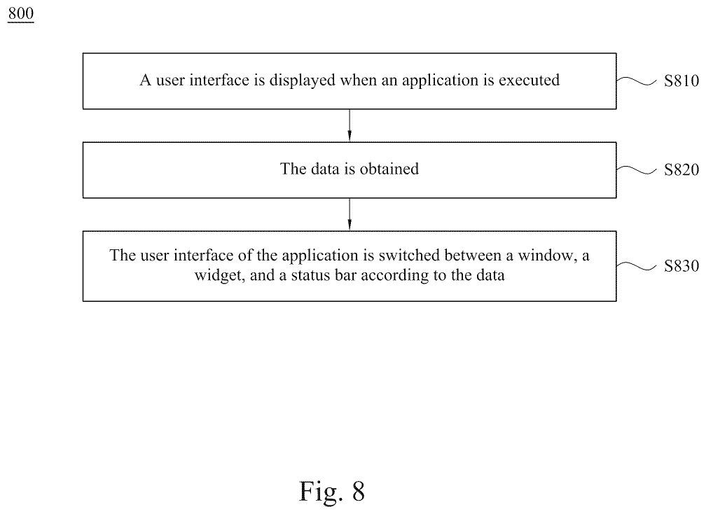

A description is provided with reference to FIG. 2 and FIG. 8. FIG. 8 depicts a schematic diagram of a display method 800 according to some embodiments of the present disclosure. In some embodiments, the display method 800 can be performed by the display device 200 of FIG. 2. In some embodiments, the display method 800 includes steps S810, S820, and S830. In some embodiments, step S810 can be performed by the display 220 of the display device 200, and steps S820 and S830 can be performed by the processing circuit 231 included in the computing system 230 of the display device 200 through accessing data and instructions in the memory device 232. In some embodiments, the memory device 232 corresponds to a non-transitory computer readable recording medium. The non-transitory computer readable recording medium is configured to store a plurality of instructions. When the processing circuit 231 executes these instructions, the processing circuit 231 performs operations of steps S820 and S830. In some embodiments, step S810 can be performed by controlling the display 220 through the processing circuit 231.

In step S810, a user interface is displayed when an application is executed. In some embodiments, step S810 corresponds to step S410, and a description in this regard is not repeated.

In step S820, the data is obtained. In some embodiments, the data includes at least one of voiceprint features, past behavioral memory of a window configuration, a current activity/working type of the display device 200, a current geographical location of the display device 200, and a current time. In some embodiments, the application 233 further includes a voiceprint/sound recognition module to recognize a user identity through sound detection. As a result, user interface components are switched based on the voiceprint features of the user. For example, if the application 233, based on voiceprint features of a current speaker, recognizes his identity to be A, then the status bar 237 is switched to the window 235 according to preset data of A, for example, when the application 233 recognizes a speech command as field B. In addition, when the application 233 recognizes the speech command as field C, the window 235 is switched back to the status bar 237 to perform switching of the user interface components. For another example, if the application 233, based on the voiceprint features of the current speaker, recognizes his identity to be D, then the status bar 237 is switched to the widget 236 according to preset data of D, for example, when the speech command is field E. Additionally, when the speech command is field F, the widget 236 is switched back to the status bar 237 to perform switching of the user interface components.

In step S830, the user interface of the application is switched among a window, a widget, and a status bar according to the data. In some embodiments, the processing circuit 231 can switch a user interface of the application 233 among the window 235, the widget 236, and the status bar 237 according to at least one of the past behavioral memory of the window configuration, the current activity/working type of the display device 200, the current geographical location of the display device 200, and the current time.

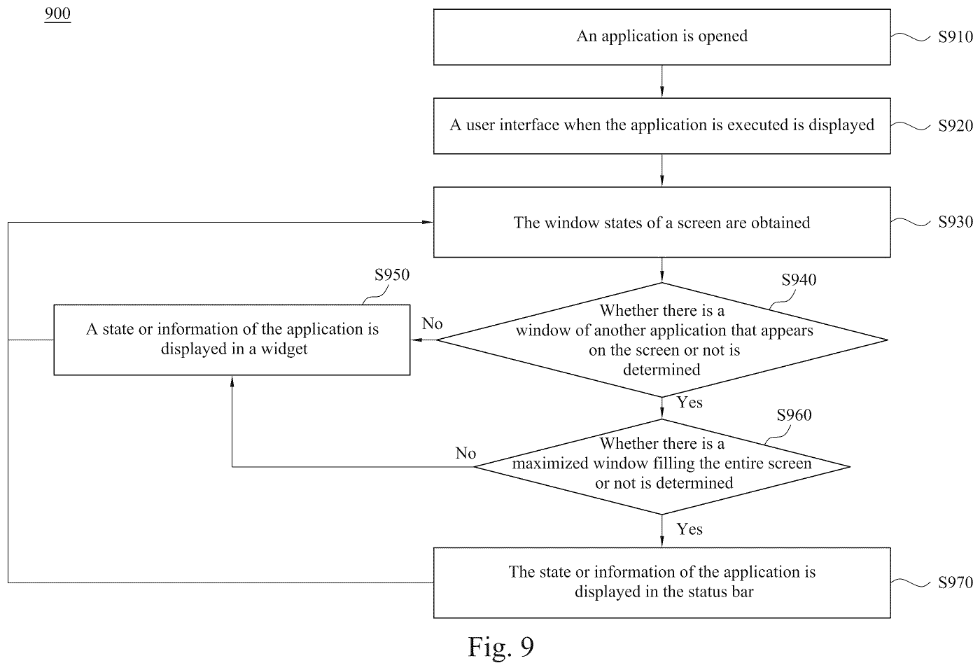

A description is provided with reference to FIG. 2 and FIG. 9. FIG. 9 depicts a schematic diagram of a display method 900 according to some embodiments of the present disclosure. In some embodiments, the display method 900 can be performed by the display device 200 of FIG. 2. In some embodiments, the display method 900 includes steps S910-S970. In some embodiments, step S920 can be performed by the display 220 of the display device 200, and step S910 and steps S930-S970 can be performed by the processing circuit 231 included in the computing system 230 of the display device 200 through accessing data and instructions in the memory device 232. In some embodiments, the memory device 232 corresponds to a non-transitory computer readable recording medium. The non-transitory computer readable recording medium is configured to store a plurality of instructions. When the processing circuit 231 executes these instructions, the processing circuit 231 performs operations of step S910 and steps S930-S970. In some embodiments, step S920 can be performed by controlling the display 220 through the processing circuit 231.

In some embodiments, based on the display methods 800 and 900, the processing circuit 231 can automatically determine the window states of programs appearing on a screen. For example, when there is a maximized window or one or more windows filling the entire screen, the status bar 237 will be displayed automatically. In addition, when there are no windows appearing on the screen or the current windows do not occupy the entire screen, the widget 236 is displayed automatically.

In step S910, an application is opened. In some embodiments, the application 233 is opened and is executed by the processing circuit 231.

In step S920, a user interface of the application is displayed when the application is executed. In some embodiments, the processing circuit 231 controls/instructs the display 220 to display a user interface when the application 233 is executed.

In step S930, the window states of a screen are obtained. In some embodiments, the processing circuit 231 obtains an arrangement or a configuration of all of the current windows appearing on the screen.

In step S940, whether there is a window of another application that appears on the screen or not is determined. In some embodiments, the processing circuit 231 determines whether there is another window that appears on the screen or not according to the aforesaid window states (for example, the configuration of all the current windows on the screen). If yes, proceed to step S960. If no, proceed to step S950.

In step S950, a state or information of the application is displayed in a widget. In some embodiments, the processing circuit 231 switches the user interface of the application 233 to the widget 236.

In step S960, whether there is a maximized window filling the entire screen or not is determined. In some embodiments, the processing circuit 231 determines whether there is a maximized window of the other application that is opened on the screen or not according to the aforesaid window states (for example, the configuration of all the current windows). In other embodiments, the processing circuit 231 determines whether the current window(s) of the other application(s) occupy the entire screen or not according to the aforesaid window states (for example, the configuration of all the current windows). If yes, proceed to step S970. If no, proceed to step S950.

In step S970, the state or the information of the application is displayed in a status bar. In some embodiments, the processing circuit 231 switches the user interface of the application 233 to the status bar 237.

In some embodiments, step S920 of FIG. 9 corresponds to step S810 of FIG. 8, and step S930 of FIG. 9 corresponds to step S820 of FIG. 8. In some embodiments, steps S940-S970 of FIG. 9 correspond to step S830 of FIG. 8. A description in this regard is not provided.

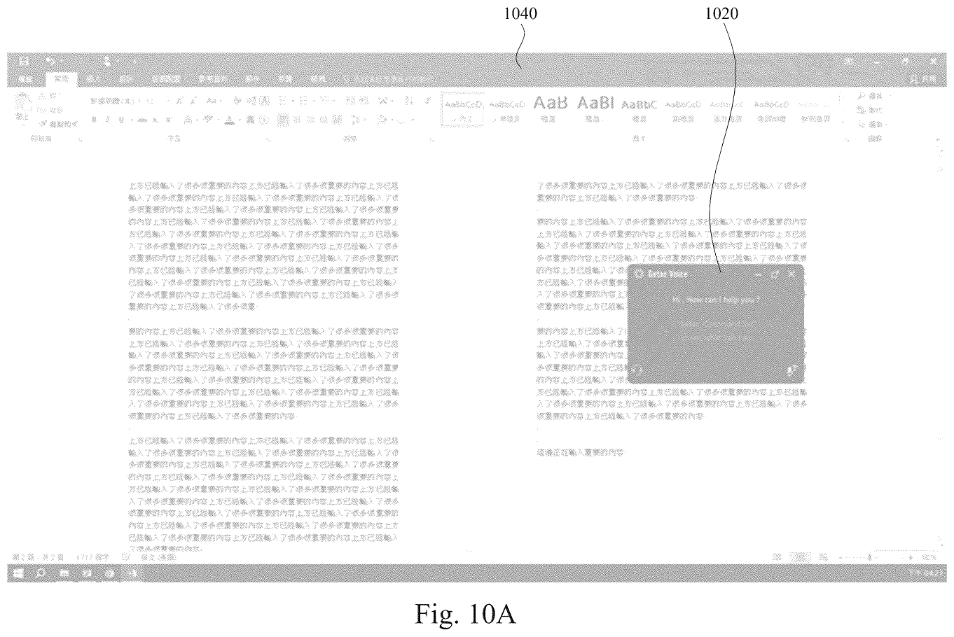

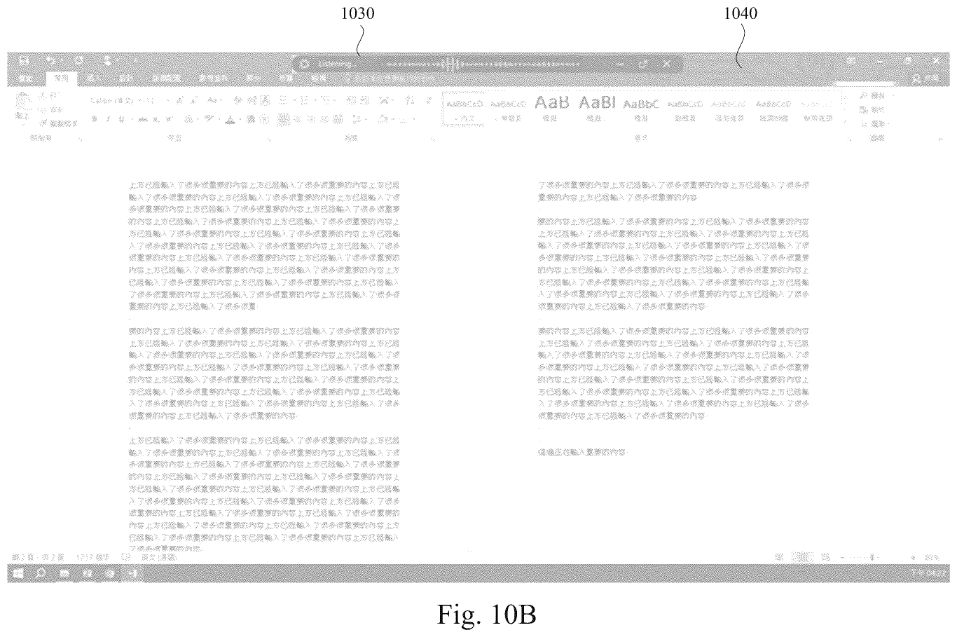

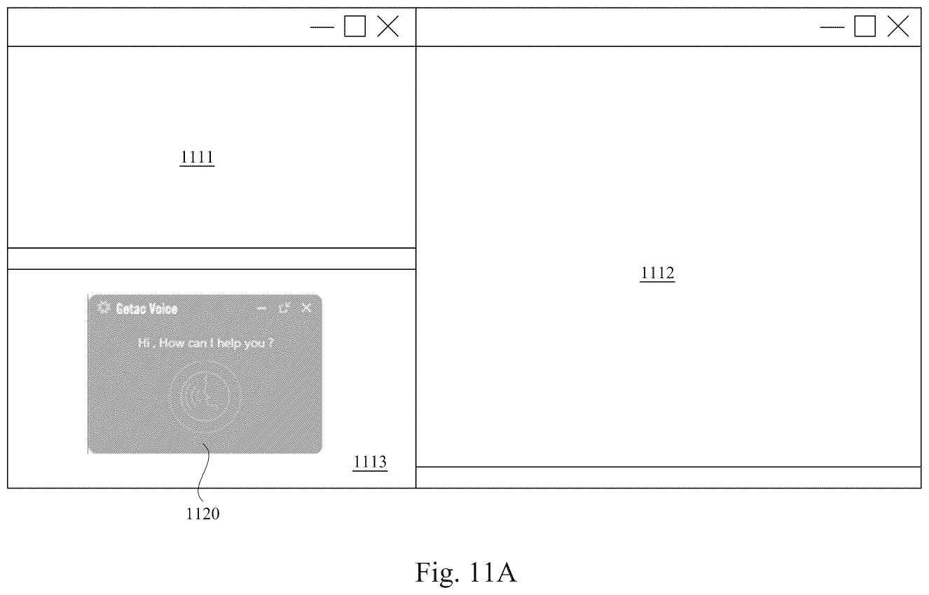

A description is provided with reference to FIG. 10A and FIG. 10B. FIG. 10A to FIG. 10B depict schematic diagrams of window configurations according to some embodiments of the present disclosure. In some embodiments, a widget 1020 and a status bar 1030 of FIG. 10A and FIG. 10B correspond to the widget 236 and the status bar 237 of the application 233 of FIG. 2. As shown in FIG. 10A, when the widget 1020 of an application is displayed above an application window 1040, and taking into account that the application window 1040 is a maximized window, a user interface of the application is switched from the widget 1020 to the status bar 1030 based on the display method 800 or 900, as shown in FIG. 10B.

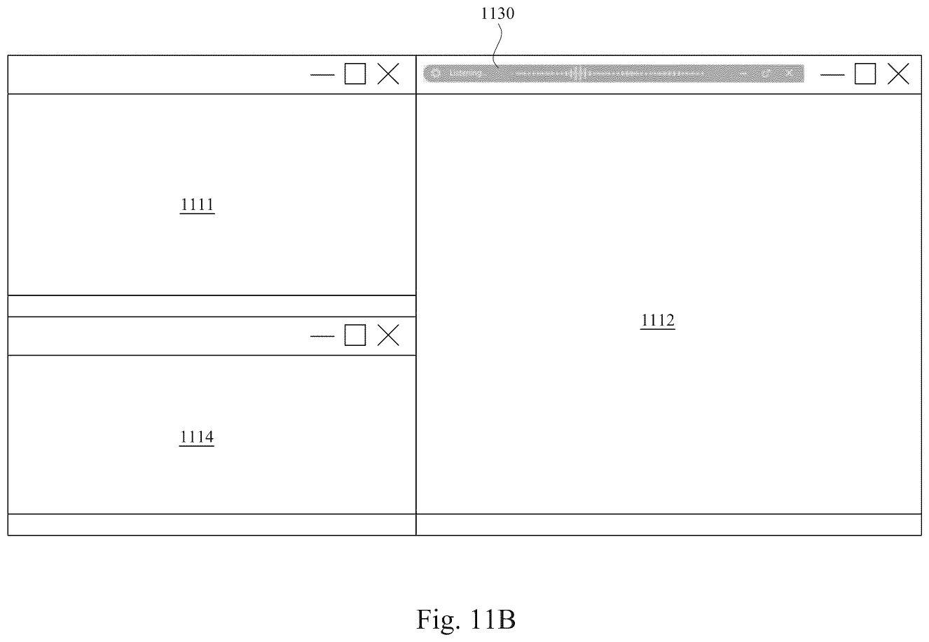

A description is provided with reference to FIG. 2, FIG. 8, FIG. 11A, and FIG. 11B. FIG. 11A to FIG. 11B depict schematic diagrams of window configurations according to some embodiments of the present disclosure. In some embodiments, the widget 1020 and the status bar 1030 of FIG. 11A and FIG. 11B correspond to the widget 236 and the status bar 237 of the application 233 of FIG. 2. In some embodiments, the embodiments of FIG. 11A and FIG. 11B can be performed according to steps S810-S830 of the display method 800 in FIG. 8. In some embodiments, in step S820 of the display method 800, the data is obtained. The data may include window configurations of the existing windows of FIG. 11A and FIG. 11B. As shown in FIG. 11A, in the window configuration of FIG. 11A, all current application windows 1111 and 1112 do not occupy the entire screen but only occupy part of the area of the screen, so the entire screen has a remaining area 1113. The processing circuit 231 then switches a user interface of the application 233 to the widget 1120, so as to display a state and/or information of the application in the widget 1120 and move the widget 1120 to the remaining area 1113. As shown in FIG. 11B, in the window configuration of FIG. 11B, the application windows 1111-1112 and an application window 1114 occupy the entire screen, so there is no remaining area in the screen. The processing circuit 231 then switches the user interface of the application 233 to the status bar 1130, so as to display the state and/or the information of the application in the status bar 1130 and move the status bar 1130 to a title bar of the application window 1111, thus improving the situation that the user interface of the application 233 blocks content of an application window displayed below.

In summary, the display device 200 and the display methods 400, 800, and 900 thereof according to the present disclosure can improve the interferences when the user operates other application(s) through switching the user interface of the application 233 to the widget or the status bar. In addition, the application 233 has the functions of touch control and/or speech recognition to be able to switch window types depending on the user's own scenario. For example, during the driving process, the user may be more inclined to use the widget or the status bar to reduce interferences on driving. When more functional operations are needed, the user interface of the application can be switched to the application window, thus providing continuity, adaptability, and efficiency.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A display method for a display device comprising:
displaying a user interface when an application is executed;
receiving an input command; and
switching the user interface of the application between a window, a widget, and a status bar according to the input command, wherein a size of the window is larger than a size of the widget, and wherein a height of the status bar is less than a height of the widget.

2. The display method of claim 1, wherein the input command is one of a touch command or a speech command.

3. The display method of claim 1, wherein the application is an audio recording and speech recognition application, wherein the application has functions of audio recording and speech recognition, wherein the input command is a speech command, and wherein the display method further comprises:
receiving a sound signal; and
executing the application to recognize the speech command in the sound signal.

4. The display method of claim 1, wherein the height of the status bar is not greater than a height of a title bar of the window.

5. The display method of claim 1, wherein the status bar covers a portion of a title bar of an application window displayed below the status bar.

6. The display method of claim 5, wherein the height of the status bar is not greater than a height of the title bar of the application window displayed below the status bar.

7. The display method of claim 1, wherein the status bar is pinned above all other windows.

8. The display method of claim 1, wherein:
the window has a back button, wherein the back button is used to restore the window of the application to a previous user interface, and wherein the previous user interface is the widget or the status bar;
the widget has a status bar button, wherein the status bar button is used to switch the user interface of the application to the status bar; and
the status bar has a widget button, wherein the widget button is used to switch the user interface of the application to the widget.

9. The display method of claim 8, wherein each of the widget and the status bar further has a window button, and wherein the window button is used to switch the user interface of the application to the window.

10. The display method of claim 8, wherein each of the window, the widget, and the status bar further has a minimize button and a close button, wherein the minimize button is used to shrink the user interface of the application to a task bar, and wherein the close button is used to close the application.

11. The display method of claim 8, wherein each of the widget and the status bar further has a recording button or a pause button, wherein the recording button is used to start recording, and wherein the pause button is used to pause recording.

12. The display method of claim 1, wherein:
a window element of the window comprises an audio setting configuration;
a widget element of the widget comprises a working state of the application, wherein the working state is a listening state or a speech conversion state; and
a status bar element of the status bar comprises the working state of the application.

13. The display method of claim 12, wherein in the listening state the application is executed to recognize whether speech exists in an audio signal or not, and wherein the display method further comprises:
switching the working state of the application to the speech conversion state from the listening state when the speech exists in the audio signal; and
executing the application in the speech conversion state to convert an audio segment corresponding to the speech into a text record.

14. The display method of claim 12, wherein the audio setting configuration comprises a volume level of a microphone and a noise reduction button, wherein the widget element of the widget comprises a speaking prompt or a conversion complete prompt, and wherein the status bar element of the status bar comprises a digital sound waveform.

15. The display method of claim 1, wherein the display device comprises a sound sensor, a computer system, and a display, and wherein the display method further comprises:
sensing a sound signal by the sound sensor;
recognizing a speech command from the sound signal and converting the speech command into the input command by the computer system;
switching the user interface of the application between the window, the widget, and the status bar according to the input command by the computer system; and
displaying the user interface when the application is executed by the display.

16. A display method for a display device comprising:
displaying a user interface when an application is executed;
obtaining data; and
switching the user interface of the application between a window, a widget, and a status bar according to the data, wherein a size of the window is larger than a size of the widget, and wherein a height of the status bar is less than a height of the widget.

17. The display method of claim 16, wherein the data comprises at least one of voiceprint features, past behavioral memory, a current activity type, a current geographical location, or a current time.

18. The display method of claim 16, wherein the data comprises a plurality of window states, and wherein the display method further comprises:
determining whether there is a maximized window filling an entire screen or not according to the plurality of window states;
displaying a state or information of the application in the status bar when there is the maximized window; and
displaying the state or the information of the application in the widget when the maximized window does not exist.

19. The display method of claim 18, wherein the data comprises a window configuration, and wherein the display method further comprises:
determining whether all current windows occupy the entire screen or not according to the plurality of window states;
displaying the state or the information of the application in the widget and moving the widget to a remaining area when all of the current windows do not occupy the entire screen and the entire screen has the remaining area; and
displaying the state or the information of the application in the status bar when all of the current windows occupy the entire screen.

20. A non-transitory computer readable recording medium configured to store an application comprising a plurality of instructions, wherein a processing circuit performs the following operations when the processing circuit executes the plurality of instructions;
receiving an input command;
switching a user interface of the application between a window, a widget, and a status bar according to the input command, wherein a size of the window is larger than a size of the widget, and wherein a height of the status bar is less than a height of the widget; and wherein,
the user interface is displayed by a display when the application is executed.
